(19) United States
(12) Patent Application Publication
(10) Pub. No.: US 2011/0192948 A1
(43) Pub. Date: Aug. 11, 2011

(54) Shelf bracket for goods shelves

(76) Inventor: Kuang-Ping Chen, Sindian (TW)

(21) Appl. No.: 12/801,110

(22) Filed: May 24, 2010

(30) Foreign Application Priority Data
Feb. 11, 2010 (TW) 099202949

(51) Int. Cl. F16M 13/00

(52) U.S. Cl. 248/240

(57) ABSTRACT

A shelf bracket for goods shelves has a board and a fastener. The board has multiple gaps alternately formed on and recessed from the top edge of the board, each gap having a narrow opening formed in the top edge of the board and multiple hooks formed on and protruding and bent downwardly from the rear edge of the board. The fastener is pivotally mounted on the board, abuts a rearmost gap, and has a stop part pivoted to position within the narrow opening of the rearmost gap. An included angle between the top edge of the board and the rear edge of the board may be 60 degrees and 90 degrees. The shelf bracket of the present invention can be easily and conveniently assembled with a carrier frame to form a rack multi-directionally mounted on a shelf support to form a goods shelf.

### BACKGROUND OF THE INVENTION

1. Field of the Invention

The present invention is related to a goods shelf, and more particularly to a shelf bracket for goods shelves facilitating shipping and assembling.

2. Description of the Related Art

Goods shelves are useful for convenience stores, supermarkets and hypermarkets to demonstrate a variety of merchandise to be sold. A conventional goods shelf has a floorstanding shelf support and multiple racks longitudinally and separately mounted on the shelf support. Various types of merchandise are classified and demonstrated on separate layer of racks for consumer to select and purchase so as to facilitate the management of goods, effectively organize space of shopping areas, make consumers' shopping easy and stimulate consumers' desire to buy.

The shelf support of the conventional goods shelf may be two opposite metal boards, and each of the racks, which is also made of a metal material, is mounted between the two metal boards. For sake of structural stability, the metal boards are welded to the shelf support. However, due to the fixed size after welded to the shelf support, such panels are unfavorable in storage and cause difficulty in shipping. Besides, the panels fail to be used with shelf supports having different sizes. If the multiple mounting occasions and purposes are taken into account, the panels must be redesigned and rebuilt, resulting in increase of labor and material cost.

### SUMMARY OF THE INVENTION

An objective of the present invention is to provide a shelf bracket for goods shelves facilitating shipping and assembling.

To achieve the foregoing objective, the shelf bracket for goods shelves has a board and a fastener.

The board has a top edge, a rear edge, multiple gaps and multiple hooks. The gaps are formed on and recessed from the top edge of the board at intervals. Each gap has a narrow opening formed in the top edge of the board. The hooks are formed on and protrude and are bent downwardly from the rear edge of the board.

The fastener is pivotally mounted on the board, abuts a rearmost gap, and has a stop part pivoted to position within the narrow opening of the rearmost gap.

The boards are firmly assembled with a rack of a goods shelf and the gaps and the fasteners. The hooks are respectively inserted in mounting holes of a shelf support. Therefore, the shelf bracket of the present invention can be easily and conveniently assembled with a carrier frame to form the rack and mounted on a shelf support to form a goods shelf.

### BRIEF DESCRIPTION OF THE DRAWINGS

FIG. 1 is a perspective view of a first embodiment of a shelf bracket for goods shelves in accordance with the present invention;

FIG. 2 is another perspective view of the shelf bracket for goods shelves in FIG. 1;

FIG. 3 is a front view of the shelf bracket for goods shelves in FIG. 1;

FIG. 4A is a partially enlarged front view of the shelf bracket for goods shelves in FIG. 2 when a fastener remains locked;

FIG. 4B is another partially enlarged front view of the shelf bracket for goods shelves in FIG. 2 when the fastener remains open;

FIG. 5 is a perspective view of a second embodiment of a shelf bracket for goods shelves in accordance with the present invention;

FIG. 6 is a front view of a third embodiment of a shelf bracket for goods shelves in accordance with the present invention;

FIG. 7 is a perspective view of a rack mounted on the shelf brackets in FIG. 5;

FIG. 8 is a partially enlarged cross-sectional end view of the rack in FIG. 7;

FIG. 9 is a perspective view of a goods shelf using the shelf brackets in FIG. 5;

FIG. 10 is a perspective view of another rack using the shelf brackets in FIG. 1;

FIG. 11 is a partially exploded perspective view of the rack using the shelf brackets in FIG. 1; and

FIG. 12 is a partially cross-sectional end view of the rack using the shelf brackets in FIG. 1.

### DETAILED DESCRIPTION OF THE INVENTION

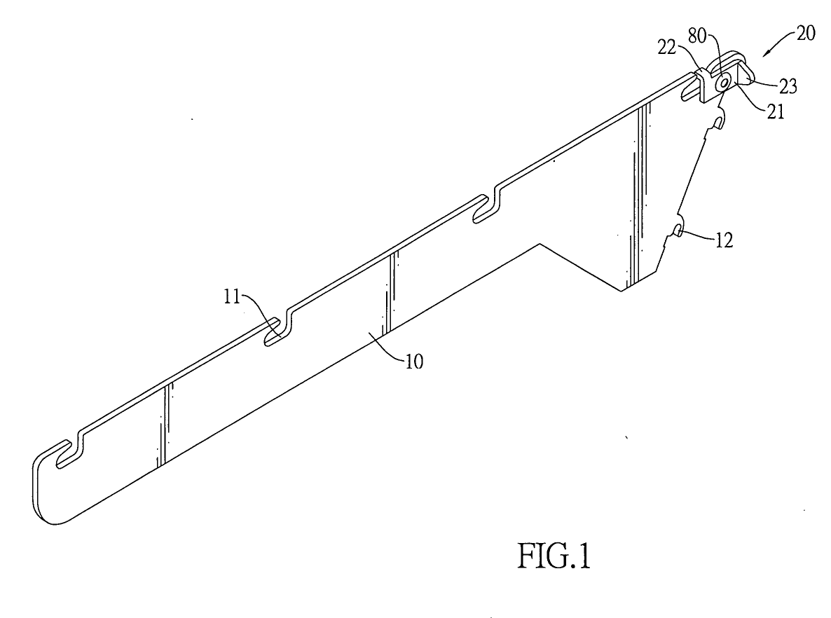

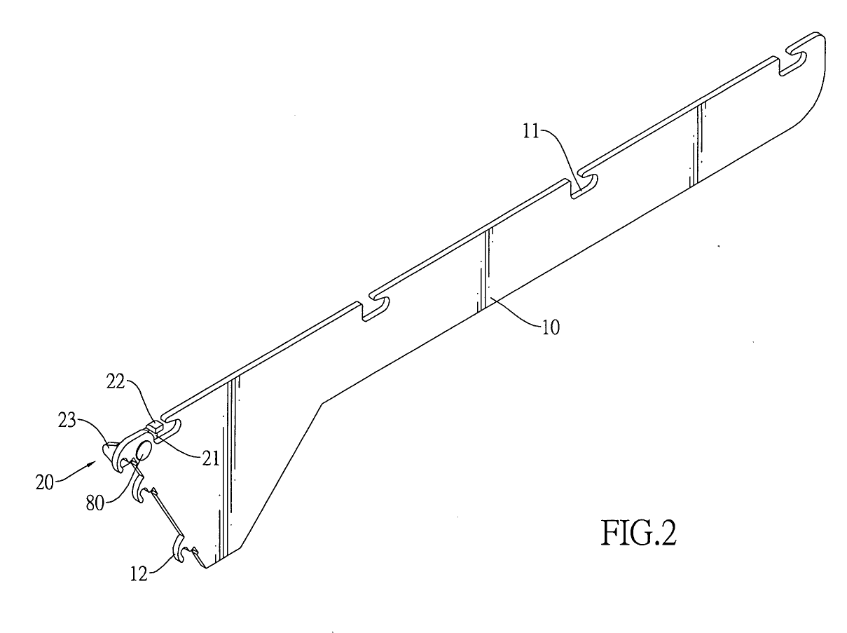

With reference to FIGS. 1 and 2, a first embodiment of a shelf bracket in accordance with the present invention has a board (10) and at least one fastener (20).

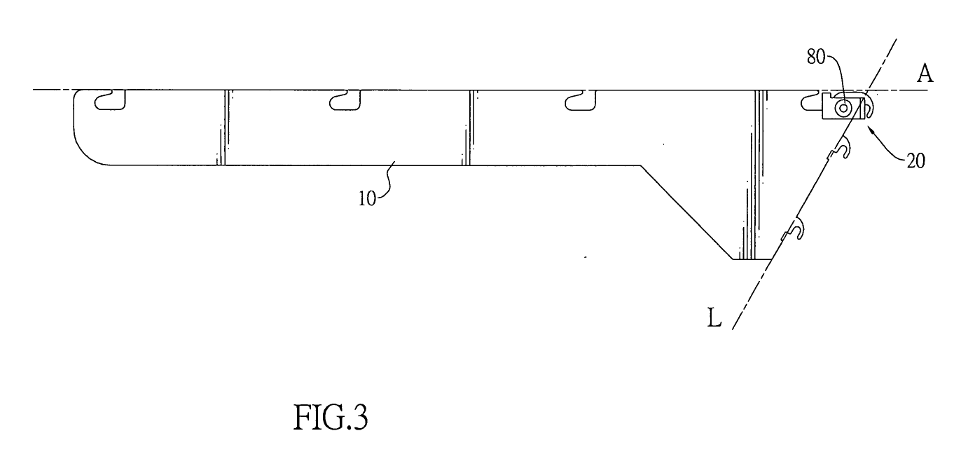

The board (10) has a top edge, a rear edge, a connection portion and a positioning portion. The connection portion is slender. The positioning portion is integrally formed with a rear end of the connection portion, extends downwardly from the rear end, and has a front slanted edge and a rear slanted edge. The board (10) has multiple gaps (11) and multiple hooks (12). The gaps (11) are formed on and recessed from the top edge of the board (10) at intervals. Each gap (11) takes an L-shaped form and has a narrow opening and a wide opening. The narrow opening is formed in the top edge of the board (10). The wide opening is formed to incise forwardly from the narrow opening, and the length of the wide opening is longer than that of the narrow opening. The hooks (12) are formed on, protrude and are bent downwardly from the rear slanted edge of the positioning portion. With reference to FIG. 3, the board (10) has a reference axis (A) attached to the top edge of the board (10) and an extended line (L) attached to the rear slanted edge. An included angle formed by the reference axis (A) and the extended line (L) is 60 degrees.

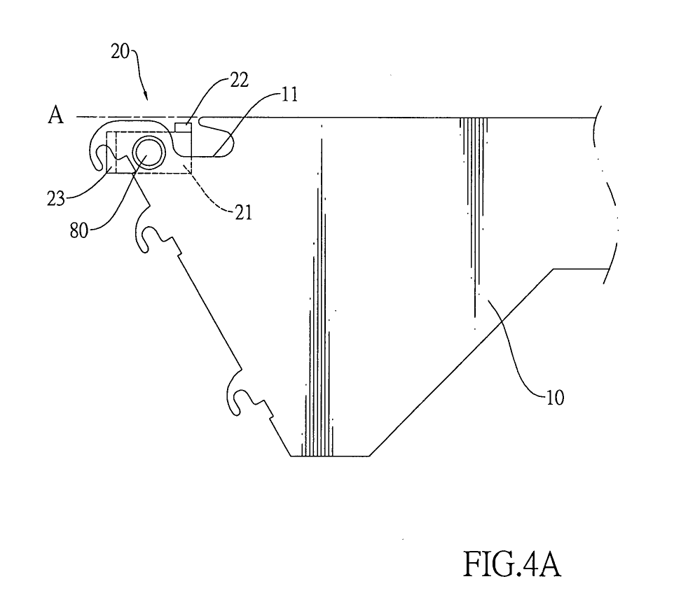

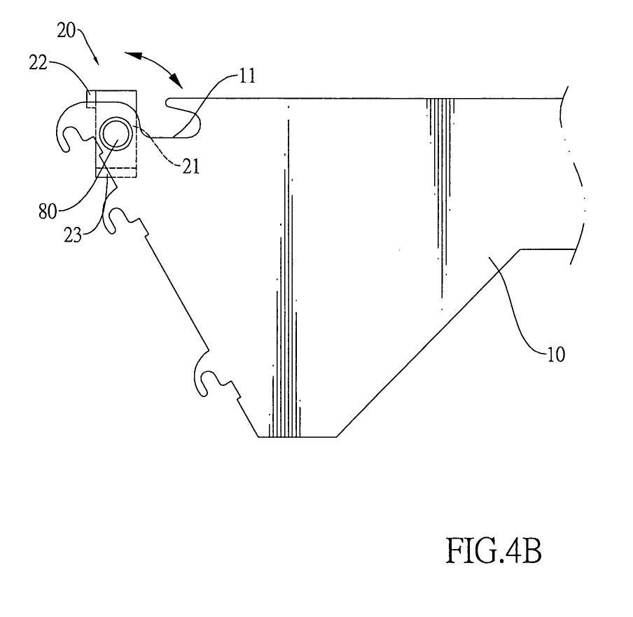

The fastener (20) is pivotally mounted on an outer side of the board, abuts a gap (11), and has a hinge part (21) and a stop part (22). The hinge part (21) has a front end, a rear end and an operation portion (23) formed on and protruding transversely outward from the rear end. The stop part (22) is formed on, protrudes transversely inward from a top portion of the front end of the hinge part (21), and selectively moves in the narrow opening of the rearmost gap. The hinge part (21) is pivoted on the board (10) by a pivoting element (80) mounted through the hinge part (21) and the board (10). With reference to FIG. 4A, the fastener (20) is pivoted to be parallel with the reference axis (A) and the stop part (22) is positioned within the narrow opening of the gap (11) to block the gap (11). With reference to FIG. 4B, the fastener (20) is pivoted to be perpendicular to the reference axis (A) and the stop part (22) is positioned away the narrow opening of the gap (11) to open the gap (11).

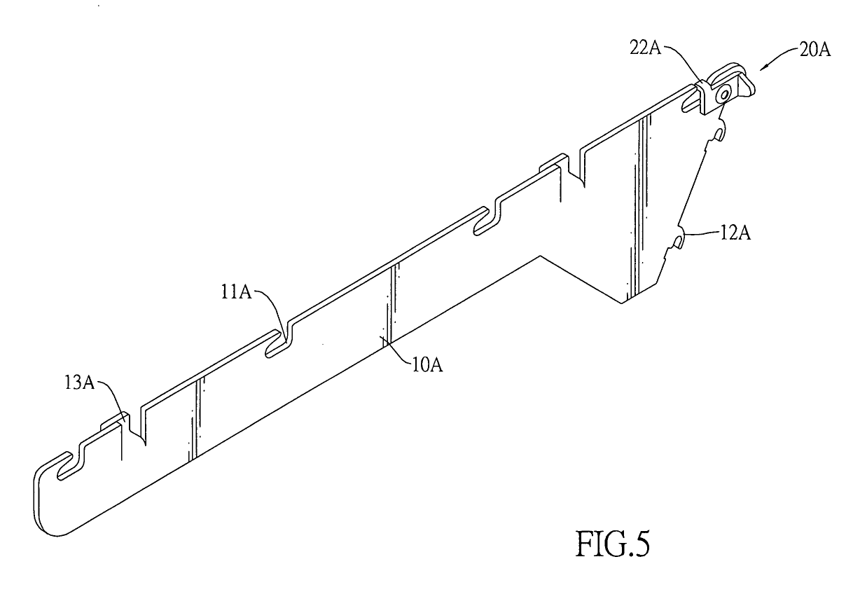

With reference to FIG. 5, a second embodiment of the shelf bracket in accordance with the present invention differs from the first embodiment by having at least one supporting seat (13A). Each supporting seat (13A) take an L-shaped form, is formed by incising two cuts downwardly from a top edge of the board, and sequentially bending a portion between the cuts transversely inward and upward.

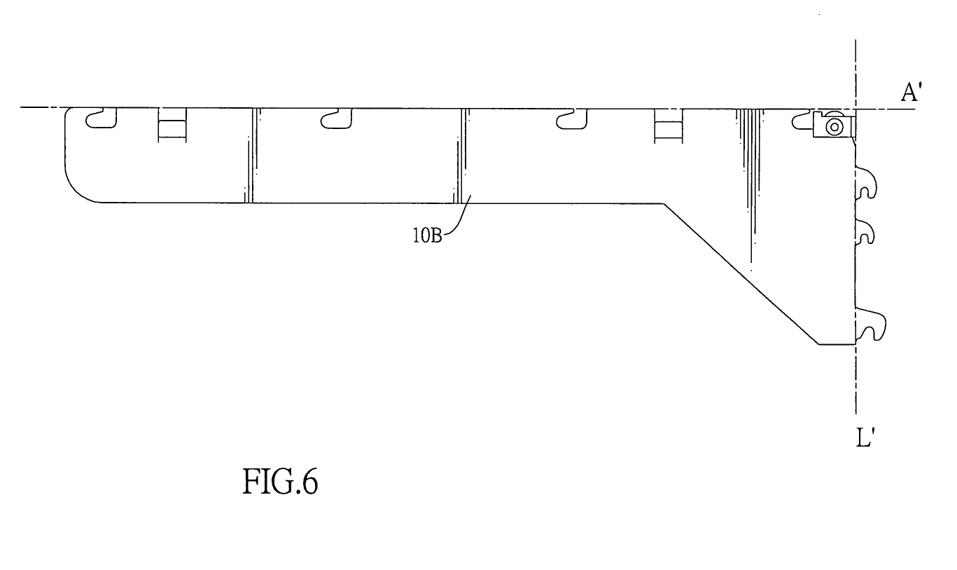

With reference to FIG. 6, a third embodiment of a shelf bracket for goods shelves in accordance with the present invention differs from the second embodiment in that a board (10B) has a reference axis (A′) attached to the top edge of the board (10B) and an extended line (L′) attached to a rear edge, and an included angle formed by the reference axis (A) and the extended line (L) is 90 degrees.

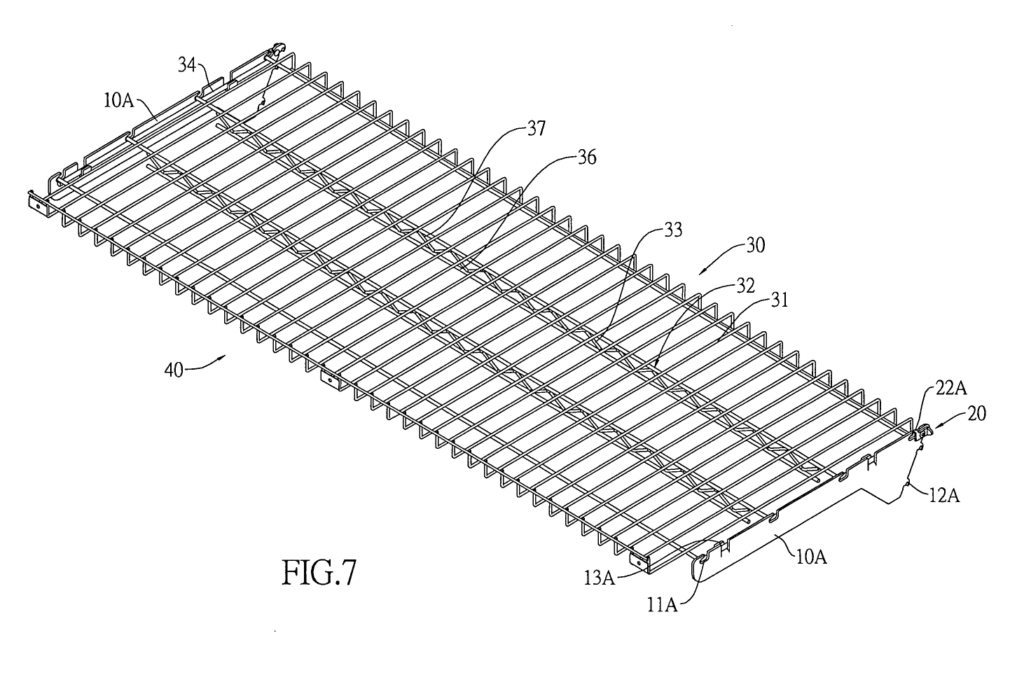

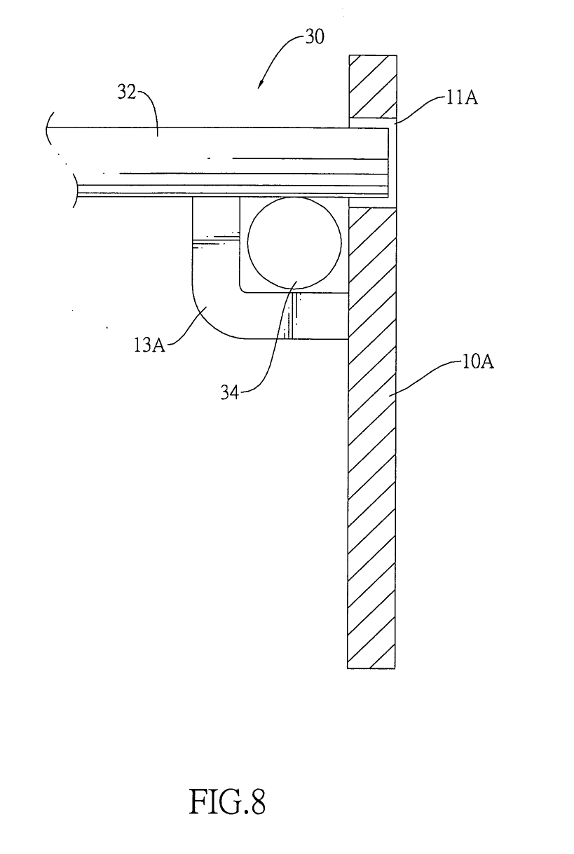

With reference to FIGS. 7 and 8, a rack (40) mounted on two separate boards (10A) has a carrier frame (30). The carrier frame (30) has multiple load-bearing bars (31), multiple intervening connection bars (32) and two side bars (34).

The load-bearing bars (31) and the intervening connection bars (32) are separated, and the load-bearing bars (31) and the intervening connection bars (32) are connected crisscross.

Each of intervening connection bars (32) between front and rear ends of the carrier frame (30) may be further connected with reinforcing structures such as a bottom bar (36) and a supporting bar (37). The intervening connection bar (32) is longer than and parallel to the bottom bar (36) the bottom bar (36).

The supporting bar (37) is zigzag and mounted between the intervening connection bar (32) and the bottom bar (36) to enhance the load-carrying capability of the carrier frame (30).

The two side bars (34) are respectively connected with both ends of the intervening connection bars (32). Two ends of the intervening connection bar (32) at the central portion of the carrier frame (30) respectively penetrate through the corresponding gaps (11A) of the boards (10A). After penetrating the corresponding gap (11A), each end must move forwards to the front end of the corresponding gap (11A). Meanwhile, each side bar (34) of the carrier frame (30) is rested on the supporting seats (13A) of one board (10A). Hence, the boards (10A) and the carrier frame (30) can be mutually positioned. Each stop part (22A) is pivoted to block the corresponding gap (11A) to confine the intervening connection bars (32) within the corresponding gaps (11A) and finish the assembly of the rack (40), thereby further firmly connecting the carrier frame (30) and the boards (10A).

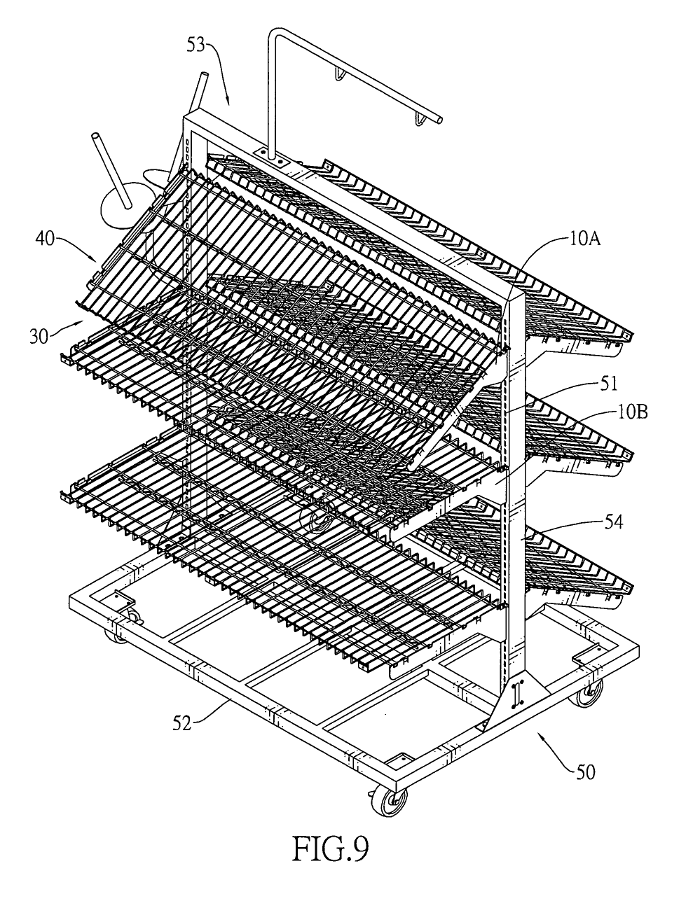

With reference to FIG. 9, a goods shelf in accordance with the present invention has a shelf support (50) and multiple racks (40). The shelf support (50) has a base frame (52) and a mounting frame (53). Both frames (52, 53) respectively have multiple rectangular tubes. The mounting frame (53) has two upright tubes (54) separately mounted on the base frame (52). Each upright tube (54) has a front side, a rear side and multiple mounting holes (51). The mounting holes (51) are respectively formed through the front side and the rear side of the upright tube (54) vertically. The racks are mounted on the shelf support (50) by inserting the hooks (12A) on the rear portion of each of the board (10A) into the corresponding holes of the upright tubes (54). The hooks (12A) of the board (10A) can insert in the mounting holes (51) at different heights. Besides, the racks (40) have two different types of the boards (10A, 10B) so that the carrier frames (30) of racks (40) can be aligned obliquely or perpendicularly relative to the upright tubes (54) to demonstrate merchandise with different fashion. The board (10A) can be flexibly assembled with the carrier frames (30) having different load-carrying capacity.

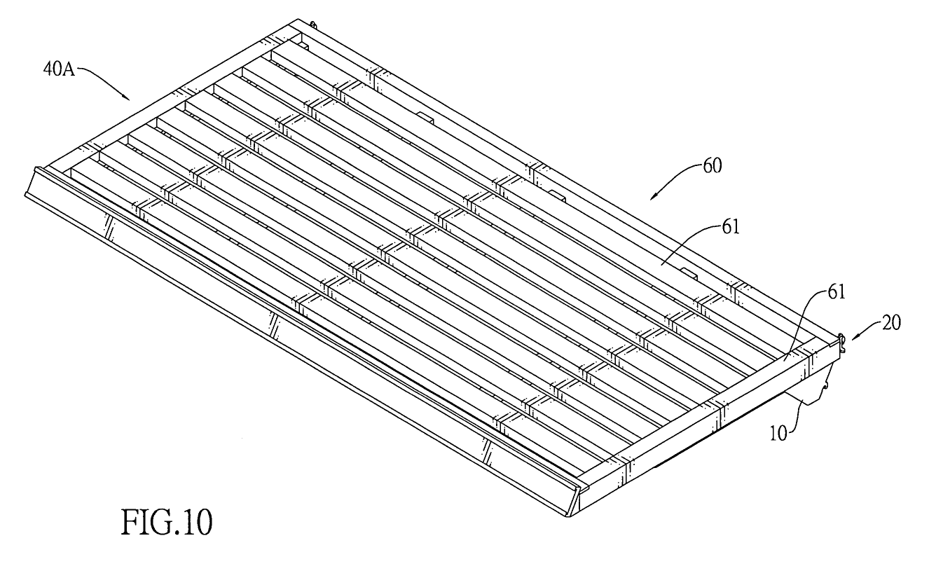

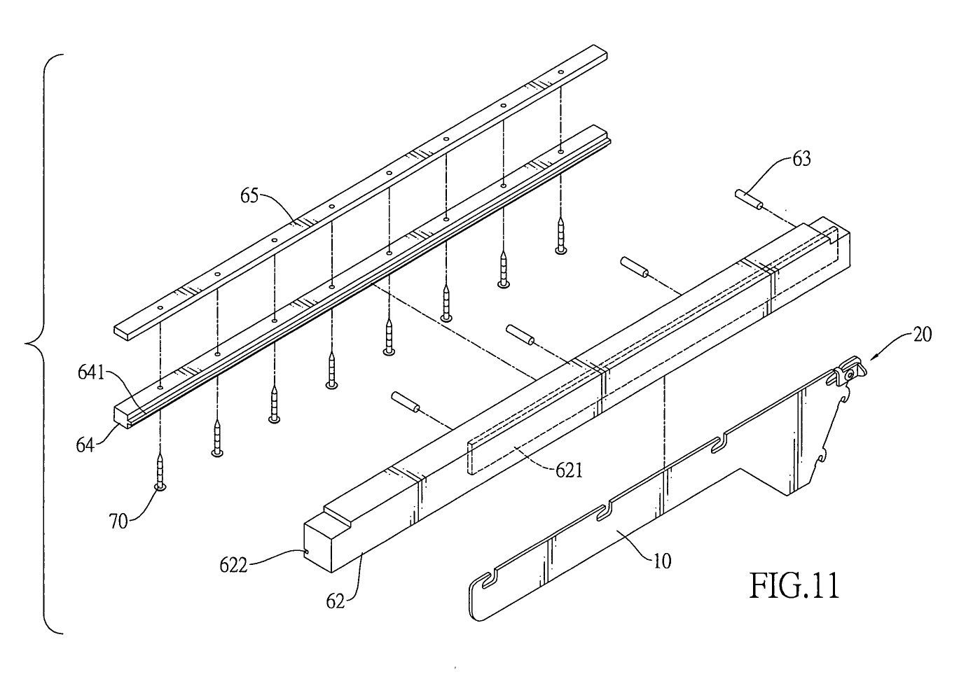

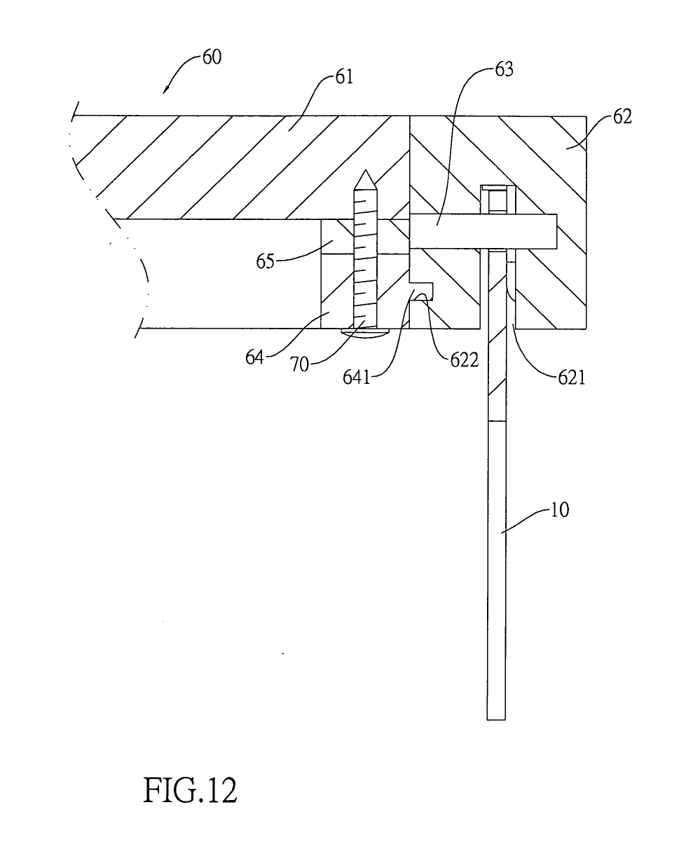

With reference to FIGS. 10 to 12, a rack (40A) using the first embodiment of the shelf bracket has a wooden carrier frame (60). The wooden carrier frame (60) has multiple support battens (61) and two side battens (62). The support battens (61) are separately and crossly connected. Each side batten (62) has a slot (621), multiple positioning pins (63), a narrow trench (622), a support band (64), a rib (641), a pad strip (65) and multiple wood screws (70). The slot (621) is recessed upwards from a bottom of the side batten (62). The positioning pins (63) insert into an inner wall of the side batten (62) and penetrate through the slot (621) of the side batten (62). The narrow trench (622) is formed in the inner wall of the side batten (62) and is lower than the positioning pins (63). The rib (641) is formed on and protrudes from a side of the support band (64) to engage the narrow trench (622) of the side batten (62). The support band (64) is mounted on the side batten (62) by inserting the rib (641) into the narrow trench (622). The pad strip (65) is mounted on a top of the support band (64) and located on the inner wall of the side batten (62) and abuts the positioning pins (63) to prevent the positioning pins (63) from coming off. The support battens (61) are mounted on the pad strip (65). The wood screws (70) penetrate through the support band (64), the pad strip (65) and screw into the corresponding support battens (61) to fasten the support band (64), the pad strip (65) and the support battens (61). The rack (40A) is assembled by sequentially inserting a top portion of each board (10) into the slot (621) of the corresponding side batten (62), respectively mounting the positioning pins (63) of each side batten (62) in the gaps (11) of the corresponding board (10), and further pivoting the fasteners (20) to confine the positioning pins (63) within the respective gaps.

Given the gaps (11), the hooks (12) and the fasteners (20), the shelf bracket of the present invention can be easily and conveniently assembled with the carrier frame (30) to form the rack (40) and mounted on a shelf support to form a goods shelf. Different shape of the positioning portion of the board (10) allows the shelf bracket to be mounted with different orientation relative to the shelf support and the shelf bracket can be assembled with carrier frame with different size, thereby addressing a more flexible way in demonstrating goods.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A shelf bracket for goods shelves, comprising:
a board having:
a top edge;
a rear edge;
multiple gaps formed on and recessed from the top edge of the board at intervals and each gap having a narrow opening formed in the top edge of the board; and
multiple hooks formed on and protruding and bent downwardly from the rear edge of the board; and
a fastener pivotally mounted on the board, abutting a rearmost gap, and having a stop part formed on the fastener selectively moving in the narrow opening of the rearmost gap.

2. The shelf bracket as claimed in claim 1, wherein an included angle between a reference axis attached to the top edge of the board and an extended line attached to the rear edge of the board is 60 degrees.

3. The shelf bracket as claimed in claim 1, wherein an included angle between a reference axis attached to the top edge of the board and an extended line attached to the rear edge of the board is 90 degrees.

4. The shelf bracket as claimed in claim 1, wherein each gap takes an L-shaped form and further has a wide opening formed to incise forwardly from the narrow opening, and the length of the wide opening is longer than that of the narrow opening.

5. The shelf bracket as claimed in claim 2, wherein each gap takes an L-shaped form and further has a wide opening formed to incise forwardly from the narrow opening, and the length of the wide opening is longer than that of the narrow opening.

6. The shelf bracket as claimed in claim 3, wherein each gap takes an L-shaped form and further has a wide opening formed to incise forwardly from the narrow opening, and the length of the wide opening is longer than that of the narrow opening.

7. The shelf bracket as claimed in claim 1, wherein the board further has at least one supporting seat, each taking an L-shaped form, formed by incising two cuts downwardly from a top edge of the board, and sequentially bending a portion between the cuts transversely inward and upward.

8. The shelf bracket as claimed in claim 2, wherein the board further has at least one supporting seat, each taking an L-shaped form, formed by incising two cuts downwardly from a top edge of the board, and sequentially bending a portion between the cuts transversely inward and upward.

9. The shelf bracket as claimed in claim 3, wherein the board further has at least one supporting seat, each taking an L-shaped form, formed by incising two cuts downwardly from a top edge of the board, and sequentially bending a portion between the cuts transversely inward and upwards.

10. The shelf bracket as claimed in claim 4, wherein the board further has at least one supporting seat, each taking an L-shaped form, formed to incise two cuts downwardly from a top edge of the board, and sequentially bend a portion between the cuts transversely inward and upward.

11. The shelf bracket as claimed in claim 5, wherein the board further has at least one supporting seat, each taking an L-shaped form, formed to incising two cuts downwardly from a top edge of the board, and sequentially bending a portion between the cuts transversely inward and upward.

12. The shelf bracket as claimed in claim 6, wherein the board further has at least one supporting seat, each taking an L-shaped form, formed to incise two cuts downwardly from a top edge of the board, and sequentially bending a portion between the cuts transversely inward and upward.

13. The shelf bracket as claimed in claim 1, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

14. The shelf bracket as claimed in claim 2, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

15. The shelf bracket as claimed in claim 3, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

16. The shelf bracket as claimed in claim 4, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

17. The shelf bracket as claimed in claim 5, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

18. The shelf bracket as claimed in claim 6, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

19. The shelf bracket as claimed in claim 7, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.

20. The shelf bracket as claimed in claim 8, wherein
the fastener has a hinge part having an operation portion formed on and protruding transversely outward from a rear end of the hinge part and a pivoting element pivotally mounted through the hinge part and a rear portion of the board; and
the stop part is formed on and protrudes transversely inward from a top portion of the a front end of the hinge part.
